(19) United States
(12) Patent Application Publication
(10) Pub. No.: US 2022/0138751 A1
(43) Pub. Date: May 5, 2022

(54) REMOTE SERVER PROCESSING

(71) Applicant: Curren Krasnoff, Milwaukee, WI (US)

(72) Inventor: Curren Krasnoff, Milwaukee, WI (US)

(73) Assignee: DUPLICENT, LLC, Santa Monica, CA (US)

(21) Appl. No.: 17/433,766

(22) PCT Filed: Oct. 25, 2019
(86) PCT No.: PCT/US2019/058083

§ 371 Date: Aug. 25, 2021

Related U.S. Application Data
(60) Provisional application No. 62/821,223, filed on Mar. 20, 2019.

(51) Int. Cl. G06Q 20/40; G06F 9/455; H04W 4/021

(52) U.S. Cl. CPC G06Q 20/4015; G06F 2009/45595; H04W 4/021; G06F 9/45558

(57) ABSTRACT

An application virtualization system including an application repository storing applications, wherein at least one of the applications is associated with a geofence, and a processing circuit. The processing circuit including at least one processor and memory, the memory having instructions stored thereon, that when executed by the at least one processor cause the processing circuit to, receive location data from a client device, determine a current location of the client device based on the location data, compare the current location to the geofence of the at least one application, and provide the at least one application to the client device based on the comparison, wherein the applications are not stored locally on the client device.

### CROSS-REFERENCE TO RELATED PATENT APPLICATIONS

The present Application claims the benefit of and priority to U.S. Provisional Patent Application No. 62/821,223, filed on Mar. 20, 2019, the entire disclosure of which is incorporated by reference herein.

### BACKGROUND

With the increasing use of personal devices such as smartphones, tablets, and smartwatches, establishments (e.g., stores, venues, restaurants, etc.) are creating mobile applications for download and installation onto such personal devices. However, in the aggregate, these establishment specific mobile applications take up considerable storage space on such personal devices. Additionally, downloading and installing the establishment specific mobile applications takes a period of extended time that can be irritating to users, especially in poor connection areas. Further, such download and installation requires user initiative to search for the establishment specific mobile application.

### SUMMARY OF THE INVENTION

One embodiment of the invention relates to an application virtualization system, including an application repository storing applications, wherein at least one of the applications is associated with a geofence, and a processing circuit. The processing circuit including at least one processor and memory, the memory having instructions stored thereon, that when executed by the at least one processor cause the processing circuit to receive location data from a client device, determine a current location of the client device based on the location data, compare the current location to the geofence of the at least one application, and provide the at least one application to the client device based on the comparison, wherein the applications are not stored locally on the client device.

In some embodiments, the applications are mobile applications and the client device is a smartphone. In some embodiments, the application virtualization system further including a user interface configured to receive geofence data from a user, and create a new geofence associated with one or more of the applications based on the geofence data. In some embodiments, the user interface is further configured to receive from the user preapproved spending data indicating an area where purchases having a first set of attributes are preapproved, and create a new preapproved spending geofence based on the preapproved spending data. In some embodiments, the memory further including instructions, that when executed by the at least one processor cause the processing circuit to send data to the client device for storage locally on the client device. In some embodiments, the memory further including instructions, that when executed by the at least one processor cause the processing circuit to receive real time location data from the client device. In some embodiments, the memory further including instructions, that when executed by the at least one processor cause the processing circuit to store the real time location data in a database and provide the real time location data to a third party.

Another embodiment of the present disclosure relates to a mobile device including a processing circuit including at least one processor and memory, the memory having instructions stored thereon, that when executed by the at least one processor cause the processing circuit to provide a virtualization application on the mobile device, the virtualization application configured to generate location data based on one or more received sensor signals, send location data to an application virtualization system, the location data describing a current location of the mobile device, receive virtualized application data associated with an application stored on the application virtualization system from the application virtualization system, wherein the application is associated with a current location of the mobile device, and provide the application to the mobile device, wherein the application is not stored locally on the mobile device.

In some embodiments, the one or more received sensor signals comprise near field communication (NFC) signals. In some embodiments, providing the application to the mobile device includes running the application remotely on the application virtualization system and displaying a user interface associated with the application on the mobile device. In some embodiments, the virtualization application receives data from the application virtualization system for storage on the mobile device. In some embodiments, the virtualization application is configured to provide multiple applications to the mobile device at the same time. In some embodiments, the virtualization application is further configured to provide real time location data to the application virtualization system.

Another embodiment of the present disclosure is an application virtualization system including an application virtualizer configured to provide an application to a client device based on a physical location of the client device, wherein the application is not installed on the client device, and a third party interface. The third party interface is configured to receive third party data, the third party data describing a physical interaction associated with a user of the client device at the physical location, and update the application provided to the client device based on the third party data.

In some embodiments, the third party data is inventory data and updating the application includes displaying the inventory data on the client device. In some embodiments, the third party data is point of sale data and updating the application includes completing a transaction on the client device. In some embodiments, the third party data is an advertisement associated with the physical location of the client device and updating the application includes displaying the advertisement. In some embodiments, the third party data is a webpage and updating the application includes displaying the webpage on the client device. In some embodiments, the third party data is product information associated with a product associated with the physical interaction and updating the application includes displaying the product information on the client device. In some embodiments, the third party data is an item selection associated with the physical interaction and updating the application includes adding the item to an online shopping cart on the client device.

### BRIEF DESCRIPTION OF THE DRAWINGS

The details of one or more implementations are set forth in the accompanying drawings and description below. Other features, aspects, and advantages of the disclosure will become apparent from the description, the drawings, and the claims, in which:

FIG. 1A is an illustration of a system for providing mobile applications to a user device in which the mobile applications are stored on the user device, according to some implementations;

FIG. 1B is an illustration of a system for providing mobile applications to a user device in which the mobile applications are stored on a remote server, according to some implementations;

FIG. 1C is an illustration of a system for providing mobile applications to a number of user devices in which the mobile applications are stored on a remote server, according to some implementations;

FIG. 1D is an illustration of a system for providing mobile applications that interact with third parties to a number of user devices in which the mobile applications are stored on a remote server, according to some implementations;

FIG. 2 is a block diagram illustrating a computing system for use with remotely stored mobile applications, according to some implementations;

FIG. 3 is a block diagram illustrating a third party interface for use with a computing system with remotely stored mobile applications that interact with third parties, according to some implementations;

FIG. 4 is a block diagram illustrating a user device having remotely stored mobile applications, according to some implementations;

FIG. 5 is a signal flow diagram illustrating an implementation of location based mobile applications;

FIG. 6 is a signal flow diagram illustrating an implementation of location based content items;

FIG. 7 is a signal flow diagram illustrating an implementation of location based mobile applications interacting with third parties;

FIG. 8 is a signal flow diagram illustrating an implementation of location based mobile applications performing data analysis with third parties; and

FIG. 9 is a signal flow diagram illustrating an implementation of location based mobile applications performing location based sales approval.

FIG. 10 is a signal flow diagram illustrating an implementation of remotely stored mobile applications integrating with third party software.

Like reference numbers and designations in the various drawings indicate like elements.

### DETAILED DESCRIPTION

Personal devices (e.g., smartphones, tablets, smartwatches, etc.) may install and execute applications. The applications may be establishment specific. For example, a store, a restaurant, and a theater may each have a unique application. Therefore, users may install a number of unique applications on their personal devices. However, each application consumes storage space (e.g., memory) on the device, and therefore the number of unique applications on a device is limited. With each subsequently installed application, device performance may degrade and installation of further applications may require the user to delete existing applications.

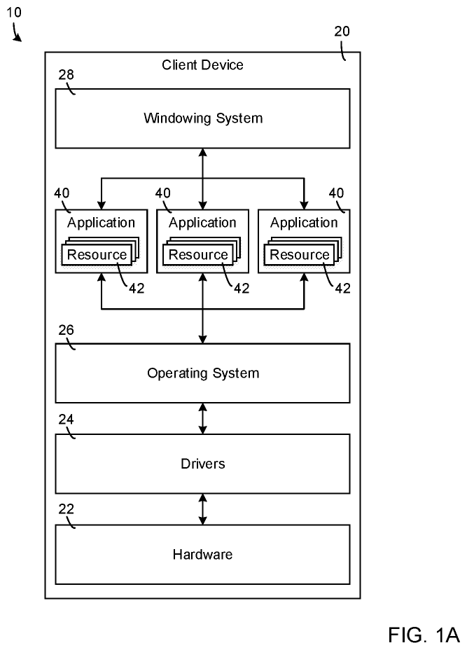

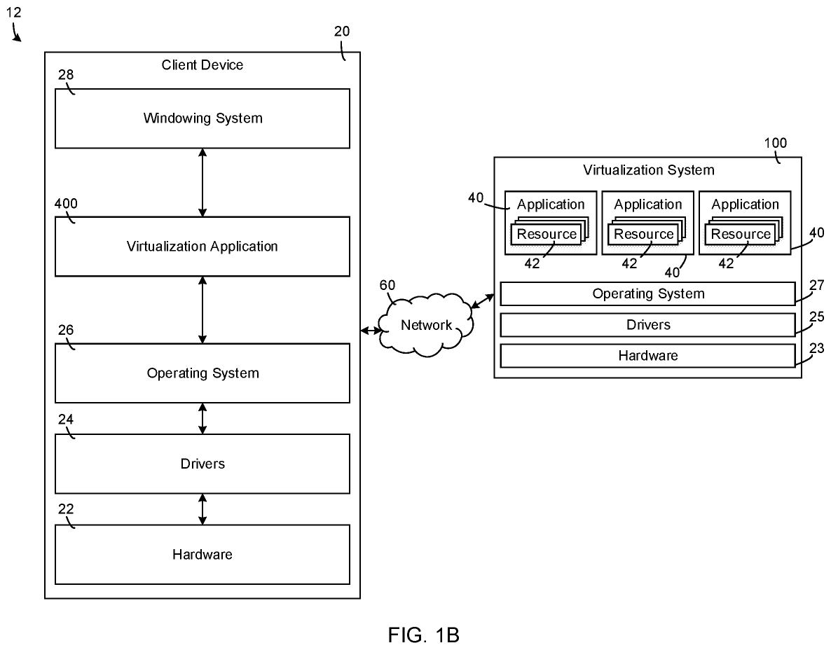

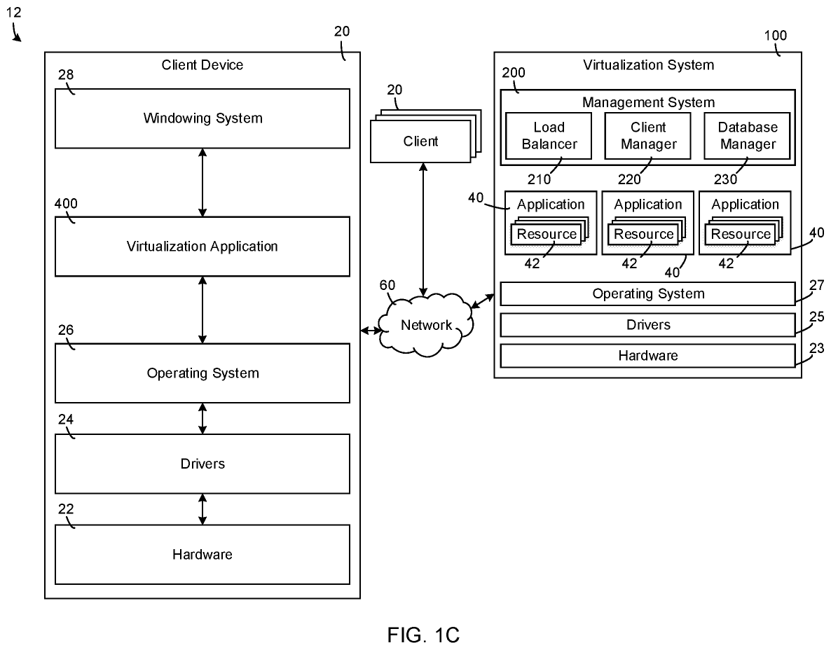

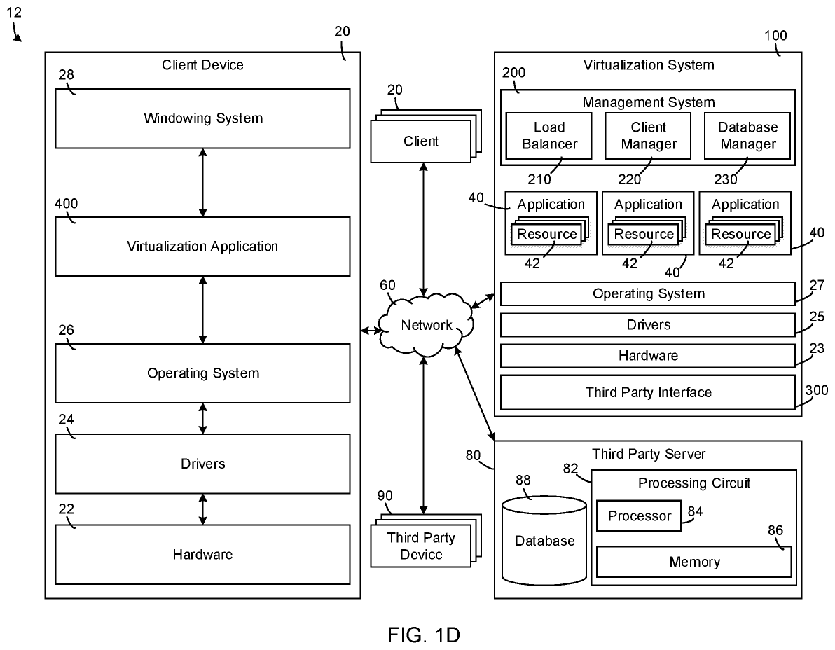

For example, FIG. 1A is a system 10 illustrating a client device 20 having multiple installed applications 40, according to some implementations. The client device 20 may be a smartphone, a laptop, a smartwatch, a tablet, or any other such device. The applications 40 are software programs that run on the client device 20. A few non-limiting example applications include, web browsers, games, e-mail programs, word processors, utilities, social media portals, calendars, inventory trackers, and point-of-sale (POI) systems. The applications 40 run on top of an operating system 26 which interacts with the client device hardware 22 via drivers 24. A windowing system 28 may present the applications 40 to a user to interact with. For example, each application 40 may present itself to the user via a graphical user interface.

Each application 40 includes resources 42 that facilitate operation of the application 40. The resources 42 may include script elements, image assets, program code, libraries, dependencies, media, and/or other data items. Each resource 42 consumes memory of the client device 20. Installing a new application 40 on the client device 20 includes installing resources 42 associated with the new application 40.

As discussed above, in many instances, a user may wish to install a number of applications 40 on the client device 20. Each application 40 consumes memory, thereby degrading the performance of the client device 20, and making it difficult or impossible to install future applications 40.

For example, still referring to FIG. 1A, the client device 20 may only be able to install three applications 40 before the memory is completely allotted. Consequently, a user may be unable to install new applications 40 without deleting the existing applications 40. Deleting old applications to install new applications may be irritating to the user and may reduce the utility of the client device 20 to the user. Furthermore, the installed applications 40 may require installation of additional resources 40 (e.g., updates, etc.). For example, a legacy application 40 may require additional program code to continue functioning. However, because the three existing applications 40 already completely allot the client device 20 memory, the client device 20 may be unable to install the additional resources 40, thereby degrading or interrupting the performance of the applications 40. In addition, general performance of the client device 20 may be negatively affected when the client device memory is completely allotted. For example, a user may be unable to take photos using a smartphone if the memory is completely allotted with applications 40. In addition to degrading the performance of the client device 20 and applications 40, and requiring extra effort by the user, locally installed applications may be cumbersome and may limit third party interaction. For example, a user may be required to download a new application for each disparate establishment and each disparate application may not be able to interact with one another or external systems. Many geographic locations may be assigned applications 40, and virtualization system 100 may process applications 40 in parallel (e.g., 10 applications 40, 50 applications 40, 500 applications 40, 5,000 applications 40, 50,000 applications 40, 500,000 applications 40, 50,000,000 applications 40, or more applications 40), for the various client devices 20 while at the assigned locations. Virtualization system 100 may simultaneously support applications 40 for use at each location and many client devices 20 may individually run the same application 40 in parallel while at the same location (e.g. 5 client devices 20 in parallel, 10 client devices 20 in parallel, 20 client devices 20 in parallel, 50 client devices 20 in parallel, 500 client devices 20 in parallel, 5,000 client devices 20 in parallel, 50,000 client devices 20 in parallel, more client devices 20 in parallel, etc.).

Instead, the systems and methods discussed herein provide for limitless flexible applications by utilizing a virtualization system to remotely host and process client accessible applications. Applications may be installed and run on a remote virtualization system and streamed to the client device. A user may interact with the remotely hosted applications as if they were installed on the client device directly. Thus, a client device using the virtualization system may facilitate interaction with a limitless number of applications without the drawbacks associated with memory allocation.

For example, FIG. 1B is a system 12 illustrating a virtualization system 100 to remotely host and stream applications 40 to the client device 20. The virtualization system 100 includes hardware 23, drivers 25, and an operating system 27 to run applications 40 separately of the client device 20. Virtualization system 100 may be a server to store and process applications 40. Virtualization system 100 may be a server, distributed processing system, and/or any other data processing system. For example, virtualization system 100 may be distributed across multiple networked servers in multiple locations. The applications 40 may be installed on the virtualization system 100 and streamed to the client device 20 via a network 60. A user may interact with the streamed applications as if they were installed locally on the client device 20. In some embodiments, the applications 40 are streamed to a virtualization application 400 installed on the client device 20. The virtualization application 400 may be a thin client operating system, virtual operating system, hosted shared desktop, desktop virtualizer, application streamer, or any other software to facilitate a connection with the virtualization system 100 and display of and interaction with the streamed applications. In various embodiments, the user selects an application 40 from a list of applications via the virtualization application 400. Instead of being downloaded to the client device 20, the application 40 is streamed to the client device 20. Therefore, the user may use applications 40 without installing them on the client device 40, thereby saving memory and improving the client device 20 and application 40 performance. Furthermore, the user doesn't need to download a new application every time they wish to interact with a new establishment because the applications 40 are already installed on the virtualization system 100. Instead, the user selects the application 40 from a list of preinstalled applications.

Applications 40 may be customized by a user (e.g., owners, representatives, corporate entities, etc.) that manage the location for which application 40 is assigned or by administrators to the virtualization system 100. Applications 40 may be designed from various templates for various types of establishments (e.g., restaurants, grocery stores, retail stores, sporting good stores, consumer electronics stores, coffee shops, gyms, home stores, gas stations, etc.). Applications 40 may be designed to have various functionality such as inventory searching, receiving product information, product purchasing, communication with the location (e.g. placing an order, asking for help), receiving promotions, a product shopping cart, remembering customer past purchases, product recommendations, store mapping, location information (e.g. restroom locations and door codes, etc.), and/or providing advertisements. Various styles, layouts, colors, of applications 40 may be used with various integration features compatible across various types of client devices 20.

As discussed above, the virtualization system 100 may facilitate interaction with a limitless number of applications 40. Unlike the client device 20, the virtualization system 100 is not constrained by memory capacity. The virtualization system 100 may scale to accommodate any number of applications 40 and clients 20.

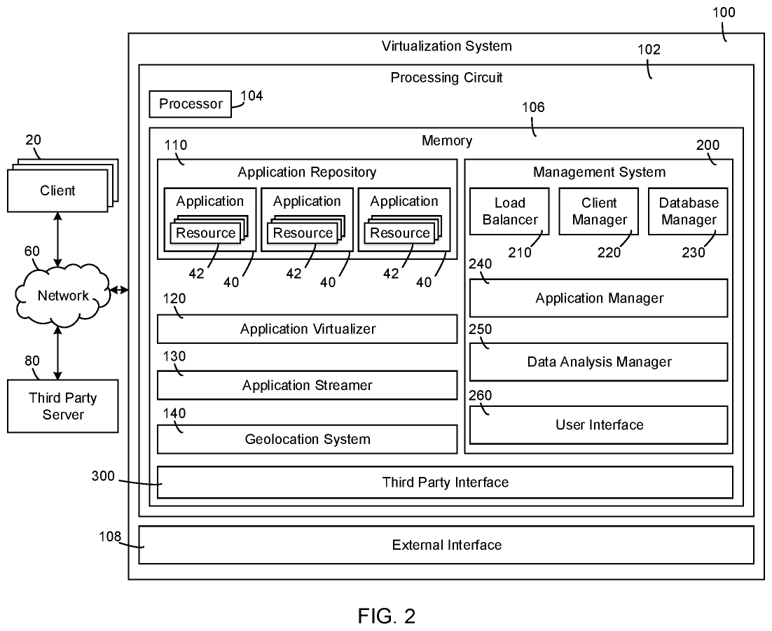

For example, FIG. 1C is the system 12 illustrating the virtualization system 100 scaled to accommodate a number of clients 20. In some embodiments, the virtualization system 100 is a distributed system. For example, the virtualization system 100 may be a cloud computing system distributed over multiple locations. In some embodiments, virtualization system 100 is configured to support parallel access to applications 40 by multiple client devices 20. For example, virtualization system 100 may facilitate many simultaneous users to access the same application 40 as a single geographic location while at the same geographic location. Additionally or alternatively, virtualization system 100 may facilitate running various applications 40 of various designs and computing requirements, across many geographic locations, such that one or more users at each of the many geographic locations may interact with the application 40 simultaneously, yet individually. Users' interactions with applications 40 do not interfere with one another. In some embodiments, the virtualization system 100 is an application as a service (AaaS) system or an application platform as a service (APaaS) system. The virtualization system 100 may include a management system 200 to facilitate management of clients 20 and applications 40. The management system 200 may include a load balancer 210, a client manager 220, and a database manager 230. The load balancer 210 may oversee the computing resources of the virtualization system 100. For example, the load balancer 210 may distribute client 20 requests between one or more distributed cloud computing systems of the virtualization system 100. The client manager 220 may track clients 20 and route client requests within the virtualization system 100. Client manager 220 may manage identifying information for each of client devices 20. For example, client manager 220 may store credit card information for a specific client device 20 and/or user. In some embodiments, client manager 220 tracks past purchases associated with a user. For example, client manager 220 may tracks past purchases associated with a user and a specific location. Client manager 220 may store user specific information in virtualization system 100, third party server 80, and/or on client device 20. Additionally or alternatively, any of the processes performed by client manager 220 may be performed by virtualization application 400 on client device 20. The database manager 230 may govern data storage within the virtualization system 100. For example, database manager 230 may control read and write access to memory or databases within the virtualization system. The management system 200 is discussed in detail below with reference to FIG. 2.

As discussed above in connection to FIG. 1A, applications 40 hosted on the client device 20 may not be able to interact with one another or external systems. However, applications 40 hosted on the virtualization system 100 may interact with one another and external systems, thereby facilitating new functionality for applications 40.

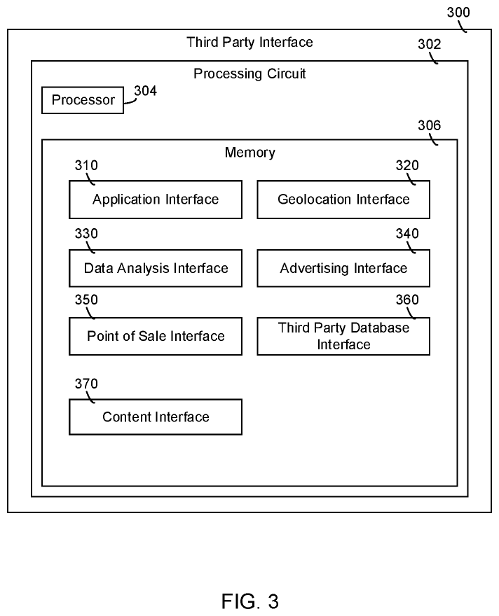

For example, FIG. 1D is the system 12 illustrating the virtualization system 100 configured to interact with a third party server 80. The third party server 80 may be an establishment backend server such as an inventory management system or point of sale system, a security system, a web-server, or any other third party functional computational architecture. In various embodiments, the virtualization system 100 may interact (directly or indirectly) with a number of third party devices 90 such as sensors, point of sale terminals, security cameras, or any other third party device. The third party server 80 may include a processing circuit 82 having a processor 84 and memory 86. In various embodiments, the third party server 80 includes a database 88. The virtualization system 100 may interact with the third party server 80 via a third party interface 300. The third party interface 300 may include hardware and software to facilitate uniform interaction with third parties. For example, the third party interface 300 may include an application programming interface (API) such that third parties may send and receive data in a standardized format. The third party interface 300 is discussed in detail below with reference to FIG. 3. In various embodiments, the applications 40 may interact with one or more third parties via the third party interface 300, thereby facilitating new functionality for applications 40. For example, the virtualization system 100 may interact with a number of in-store sensors to determine a location of a user in a store and may facilitate displaying coupons to the user based on the determined location of the user. As a further example, the virtualization system 100 may interact with a third party server 80 to determine when a user has interacted with merchandise at a store and facilitate displaying merchandise information to the user. As a further example, store employees may update inventory information in third party servers (e.g., server 88) to reflect inventory information relayed through the store application 40. Therefore, the virtualization system 100 not only improves the functioning of the computing systems of client device 20 by reducing memory allocation and improving application performance, but also provides the unique system 12 for limitless flexible applications that are convenient and engaging for users. In some embodiments, virtualization system 100 is or includes an internal server (e.g., associated with an establishment) that facilitates virtualization of applications 40 and storage of applications 40 and other software to run applications 40. Additionally or alternatively, virtualization system 100 may be expanded (e.g., to have greater processing and/or storage capabilities) across one or more distributed processing systems. For example, virtualization system 100 may run on a distributed server architecture such as Amazon web services (“AWS”). In some embodiments, third party server 80 facilitate storage and interaction with non-in-service provided software (e.g., outside supply chain management software, inventory management software, etc.).

In some embodiments, client device 20 is configured to determine its current location and transmit its current location to virtualization system 100 (e.g., for geofencing purposes, etc.). In some embodiments, client device 20 prompts the user to verify their current location to confirm they are at the establishment that the current location is indicating (e.g., “Are you at establishment A?”, “Are you at establishment B or C?”, etc.). Such verification may be useful in systems with less precise tracking capabilities and/or for locations where establishments are close together or in buildings with multiple floors. Client device 20 may be configured to receive access to an “establishment specific application” from virtualization system 100 based on the current location of client device 20. In various embodiments, establishments may register their geographic location for approval within system 12, and a repository of geographic boundaries may be stored and maintained within system 12, such that there is not overlap of geographic boundaries for delivery of applications 40 within system 12, and that location geographic boundaries are accurate.

Turning now to FIG. 2, a block diagram illustrating an implementation of the virtualization system 100 computing system is shown. In many implementations, virtualization system 100 includes a processing circuit 102 having a processor 104 and memory 106. Memory 106 may store machine instructions, that when executed by processor 104 cause processor 104 to perform one or more of the operations described herein. Processor 104 may include a microprocessor, ASIC, FPGA, etc., or combinations thereof. In many implementations, processor 104 may be a multi-core processor or an array of processors. Memory 106 may include, but is not limited to, electronic, optical, magnetic, or any other storage devices capable of providing processor 104 with program instructions. Memory 106 may include a floppy disk, CD-ROM, DVD, magnetic disk, memory chip, ROM, RAM, EEPROM, EPROM, flash memory, optical media, or any other suitable memory from which processor 104 can read instructions. The instructions may include code from any suitable computer programming language such as, but not limited to, C, C++, C#, Java, JavaScript, Perl, HTML, XML, Python and Visual Basic.

Virtualization system 100 may include an external interface 108 (e.g., network interface, etc.). The external interface 108 may include any type and form of interface, including Ethernet including 10 Base T, 100 Base T, or 1000 Base T (“Gigabit”); any of the varieties of 802.11 wireless, such as 802.11a, 802.11b, 802.11g, 802.11n, or 802.11ac; cellular, including CDMA, LTE, 3G, or 4G cellular; Bluetooth or other short range wireless connections; or any combination of these or other interfaces for communicating with a network. In many implementations, virtualization system 100 may include a plurality of external interfaces 108 of different types, allowing for connections to a variety of networks, e.g. such as the Internet via different sub-networks. The external interface 108 may facilitate connections to network 60, clients 20, and/or third party server 80. In various embodiments, the virtualization system 100 connects to a plurality of third party servers 80 via the external interface 108. Third party servers 80 may interact with third party interface 300 via external interface 108.

As shown in FIG. 2, (i) virtualization system 100 and client 20 are configured to communicate (e.g., using a first communication protocol, using a long-range wireless communication protocol, cellular, radio, etc.), (ii) virtualization system 100 and third party server 80 are configured to communicate (e.g., using a second communication protocol, using a long-range wireless communication protocol, using a wired communication protocol, cellular, radio, an Internet connection, etc.), (iii) virtualization system 100 and third party device 90 are configured communicate (e.g., using a third communication protocol, using a long-range wireless communication protocol, using a wired communication protocol, an Internet connection, cellular, radio, etc.), (iv) client 20 and virtualization system 100 are configured to communicate (e.g., using a fourth communication protocol, using a short-range wireless communication protocol, Bluetooth, Bluetooth low energy (“BLE”), near-field communication (“NFC”), radio frequency identification (“RFID”), Wi-Fi, etc.), and/or (v) third party server 80 and third party device 90 are configured to communicate (e.g., using a fifth communication protocol, using a long-range wireless communication protocol, using a short-range wireless communication protocol, using a wired communication protocol, an Internet connection, cellular, radio, Bluetooth, Bluetooth low energy (“BLE”), near-field communication (“NFC”), radio frequency identification (“RFID”), Wi-Fi, etc.). In some embodiments, third party server 80 functions as an intermediary device that facilitates data transmissions between virtualization system 100 and client 20.

In some embodiments, third party server 80 is configured to act as an intermediary between virtualization system 100 and client 20. Such an intermediary may be useful in locations where cellular reception is lacking or weak. In some embodiments, third party server 80 is used in place of virtualization system 100 and performs the functions thereof. By way of example, third party server 80 may be configured to store and remotely process an establishment specific application for the establishment it is associated with. Third party server 80 may be configured to provide access to the establishment specific application to a respective client 20 based on client 20 being within communication range of third party server 80 and/or third party device 90 without the respective client 20 having to locally download and store the establishment specific application. In some embodiments, third party server 80 is configured to track activity on client 20 and/or at the establishment. Such activity may be purchases made by client 20, online purchases made remotely for pick-up at the establishment, purchases within the establishment not using client 20 (e.g., via a traditional register at the establishment, via third party server 80 at the establishment, etc.), etc. Based on such activity, third party server 80 may be configured to update the establishment specific application for the respective establishment based on the activity to provide realtime inventory and purchasing capabilities on client 20. In some embodiments, third party server 80 is an edge cloud computing system. For example, third party server 80 may be configured to store and process an establishment specific application and provide access to the establishment specific application to client 20 by drawing data from one or more other third party servers 80 and/or virtualization system 100. To continue the example, the establishment specific application data may be stored on the edge cloud computing third party server 80 and retrieve purchasing data and inventory data from one or more third party servers 80 and/or virtualization system 100. In some embodiments, third party server 80 and/or third party device 90 may be located with substantial proximity to a respective establishment. For example, a third party device 90 which communicates with client device 20 may be located near an entrance of a store for easy connection to the client device 20. To continue the example, the third party device 90 may supply the virtualized application to client device 20 and may terminate visualization of the application when client device 20 leaves the geofence and/or a communication range of the third party device 90. In some embodiments, third party server 80 stores one or more applications 40. Additionally or alternatively, third party server 80 may store dependencies of applications 40 stored on virtualization system 100. For example, an application 40 stored on virtualization system 100 may have dependencies (e.g., script libraries, assets, parameters, data, etc.) stored across multiple third party servers 80. Third party servers 80 and/or client device 20 may store information locally. For example, client device 20 may store information that may be accessed at any location and/or that may be accessed by a location specific application.

Virtualization system 100 may include in memory 106 an application repository 110 having a number of applications 40. Applications 40 may be an application, applet, script, service, daemon, routine, or other executable logic for receiving content and displaying or otherwise outputting content via an interface of the client 20 (e.g. display, speaker, etc.). In some implementations, applications 40 may be a web browser, mail client, video player, music player, video game, or any other such application. The applications 40 may include functionality for displaying content received via external interface 108 and/or generated locally by processor 104. In some implementations, applications 40 may be a media player or include an embedded media player, such as a plug-in or native media player within a web browser. Such applications 40 may include a command line interface, graphical user interface, or any combination of these or other interfaces. Virtualization system 100 may facilitate applications 40 to share data. For example, a first application 40 associated with a first location may share pricing data with a second application 40 associated with a second location. Additionally or alternatively, one or more applications 40 may be stored outside of virtualization system 100. For example, an application 40 may be stored on third party server 80 and run by virtualization system 100 without being installed on virtualization system 100.

Memory 106 may include application virtualizer 120, application streamer 130, geolocation system 140, and third party interface 300 and management system 200 as discussed above. Application virtualizer 120 may encapsulate applications 40 for execution on virtualization system 100. In various embodiments, application virtualizer 120 runs an instance of the application 40 on the hardware (e.g., processing circuit 102) of virtualization system 100. In some embodiments, application virtualizer 120 is multitenant (e.g., runs a single version of each application 40). Application virtualizer 120 may redirect user input and output operations to application streamer 130 for transmission to client device 20. For example, application virtualizer 120 may execute an application 40 in a runtime environment of the virtualization system 100 while sending user interface elements of the application 40 to application streamer 130 and receiving user input from application streamer 130 as if from the user directly.

Application streamer 130 may prepare and send application data between virtualization system 100 and client device 20. For example, application streamer 130 may receive user input from client device 20 and send the user input to application virtualizer 120. In various embodiments, the application 40 may experience the user input received from application streamer 130 as if it was received from a user directly. As a further example, application streamer 130 may receive a user interface element from application virtualizer 120 and send the user interface element to client device 20 (e.g., as an interactable bitmap image, etc.). Application streamer 130 may utilize remote desktop protocol (RDP), HDX, RemoteFX, and any other protocol to facilitate a connection between client devices 20 and virtualization system 100. In various embodiments, application streamer 130 can format application data received from virtualization system 100 for display on different systems. For example, application streamer 130 may format application data for display on a tablet and/or for display on a smartwatch. As an additional example, application streamer 130 may format application data for display via virtualization application 400 and/or via a web browser. Application streamer 130 may seamlessly transition an application 40 from being displayed via virtualization application 400 to being displayed via a web browser without the application 40 experiencing a change in input/output routing. In various embodiments, application streamer 130 may perform signal processing on data before transmission. For example, application streamer 130 may compress some, part, or all of application 40 data before transmission. Compression may be continuous or discreet.

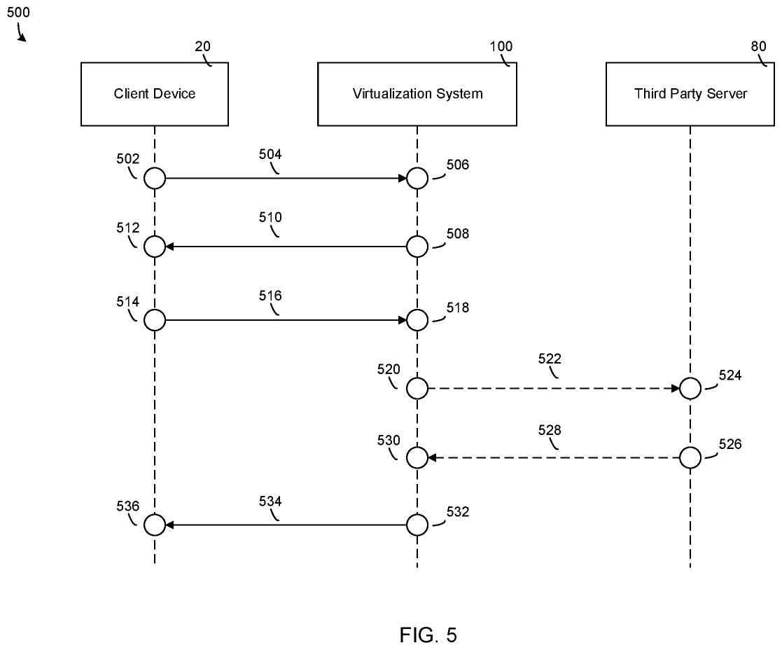

Geolocation system 140 facilitates geographic functionality for applications 40. For example, virtualization system 100 may present specific applications 40 to client device 20 when client device 20 is in a specific location. Geolocation system 140 may receive location data from client device 20. In some embodiments, geolocation system 140 receives location data from third party server 80 and/or third party devices 90. Location data may include global positioning system (GPS) data, local positioning system (LPS) data, motion capture data, ultrasonic data, trilateration data, multilateration data, near field communication (NFC) data, image data, barcode information, location area network (LAN) data, Bluetooth data, weight data, infrared data, and any other positioning data. Geolocation system 140 may determine a physical location of client device 20. In some embodiments, geolocation system 140 associates specific applications 40 and/or functionality with a location. For example, geolocation system 140 may facilitate establishment specific applications that are displayed to a user in response to the client device 20 being in close geographic proximity to the physical location of a respective establishment (e.g., by GPS triggering, by crossing a pre-set GPS perimeter or geofence, etc.). In some embodiments, geolocation system 140 associates specific applications 40 with different forms of location data. For example, virtualization system 100 may provide access to a first version of an application for Bluetooth location data and a second version of the same application for barcode location data. In some embodiments, a geofence may be configured to be substantially similar to the physical boundaries of an establishment. In some embodiments, application visualization is terminated when client device 20 leaves the physical location. Geolocation system 140 is discussed below with reference to FIG. 5.

Management system 200 is shown to further include application manager 240, data analysis manager 250, and user interface 260. In some embodiments, application manager 240 communicably couples to application repository 110. Application manager 240 may install and update applications 40. In some embodiments, application manager 240 interacts with external third parties via third party interface 300. For example, a third party establishment wishing to make their application available on virtualization system 100 may send a request to install their application via third party interface 300 and cause application manager 240 to install the application on virtualization system 100. In various embodiments, application manager 240 controls application versioning. In some embodiments, application manager 240 automatically updates applications 40.

Data analysis manager 250 may perform data analysis operations for virtualization system 100. For example, data analysis manager 250 may receive sensor data from a third party (via third party interface 300, for example), and GPS data from client device 20 and may analyze the received data to determine a specific location of the client device 20 within an establishment (e.g., a specific room, an isle within a store, a location relative to a display, etc.). As a further example, data analysis manager 250 may receive inventory data from a third party and determine which establishment locations have an item a user wishes to purchase. These examples are meant to be non-limiting, many other data analysis operations are possible. In various embodiments, data analysis manager 250 may interact with third party server 80 to perform data analysis. Data compiled from the user interactions with applications 40 may collectively be analyzed and complied with various systems in secondary data analysis processes, where data from applications 40 is sent through virtualization system 100 to various other third parties for further analysis. Such data may be sent to third party servers 80 and further sent back to virtualization system 100 for real time integration back into the same applications 40 from which the data originated. Data may be also sent to users (e.g., owners, representatives, corporate entities, etc.) that manage the location for which application 40 is assigned and data may be further analyzed by the users. The users that manage the location may further send data to other third party data analysis organizations directly or to third party servers 80 or back to virtualization system 100. In some embodiments, the users that manage the location or third party data analysis organizations may modify applications 40 within virtualization system 100. Location data and geographic boundaries for the geographic locations for which applications 40 are assigned may be contained within virtualization system 100 as a repository, which may be updated by an administrator to virtualization system 100 or by users that manage the location.

User interface 260 may facilitate user control of virtualization system 100. For example, an administrator may change configuration setting of virtualization system 100 via user interface 260. In some embodiments, an administrator may set up third party connections via user interface 260. For example, an administrator, via user interface 260 may connect virtualization system 100 to a third party inventory database to receive third party inventory data.

Referring now to FIG. 3, a block diagram illustrating an implementation of third party interface 300 is shown. In some embodiments, third party interface 300 is part of processing circuit 102. Additionally or alternatively, third party interface 300 may be a standalone system that interacts with virtualization system 100. Third party interface 300 is shown to include a processing circuit 302 having a processor 304 and memory 306. Memory 306 may store machine instructions, that when executed by processor 304 cause processor 304 to perform one or more of the operations described herein. Memory 306 is shown to include application interface 310, geolocation interface 320, data analysis interface 330, advertising interface 340, point of sale interface 350, third party database interface 360, and content interface 370. Application interface 310 may facilitate third party interaction with applications 40. For example, an establishment may send an update request to update an application 40 via application interface 310. In some embodiments, third parties control configuration settings associated with applications 40 via application interface 310. For example, using application interface 310 an establishment may set a geofence to determine where an application 40 is available to users. In some embodiments, external computing systems (e.g., third party server 80) may automatically update applications 40 via application interface 310.

Geolocation interface 320 may facilitate location based interaction with third parties. In some embodiments, third parties may send location data to virtualization system 100 via geolocation interface 320. For example, third party server 80 may receive multilateration data from sensors within an establishment and send the multilateration data to geolocation interface 320 to facilitate determining a location of client device 20. In some embodiments, geolocation interface 320 interacts directly with third party devices 90. For example, geolocation interface 320 may receive tracking data from a GPS device attached to a shipping container. In various embodiments, a user may configure geographic functionality of virtualization system 100 using geolocation interface 320. For example, a user may specify geographic boundaries (e.g., geofences) for applications 40.

Data analysis interface 330 may facilitate data analysis with virtualization system 100 and third party servers 80. In some embodiments, third party servers 80 and virtualization system 100 perform shared or parallel computation. For example, virtualization system 100 may combine user preference data with third party server 80 navigation data to collaboratively determine a route for a navigation application 40. As another example, virtualization system 100 and third party server 80 may collaboratively determine a location of client device 20 within an establishment and determine, based on the determined location, coupons to display to the user.

Advertising interface 340 may facilitate advertising via applications 40. Advertising interface 340 may send/receive advertising data with advertisers, ad techs, and any other advertising establishments. For example, advertising interface 340 may send user preference data to an advertiser and receive one or more content items (e.g., ads, etc.) directed towards the user. As a further example, advertising interface 340 may send location data to an advertiser and receive one or more location specific content items. In various embodiments, advertising interface 340 facilitates advertising pricing for advertisers. For example, potential advertisers may bid, via advertising interface 340, to provide content items to users via applications 40.

Point of sale interface 350 may facilitate financial transactions (e.g., sales, etc.) within applications 40. For example, point of sale interface 350 may interact with a payment processor to process a payment method (e.g., credit card, bitcoin, PayPal, Square, Venmo, etc.). Point of sale interface 350 may facilitate a receipt system that shows items purchased in an application 40. Point of sale interface 350 may facilitate online or in-store purchases via applications 40. For example, point of sale interface 350 may receive sales data client device 20 and use the sales data to complete a sales transaction with a payment processor. As a further example, point of sale interface 350 may facilitate updating inventory data. In some embodiments, point of sale interface 350 facilitates location based point of sale devices. Client device 20, using virtualization application 400, may function as a point of sale device at a farmers market, for example. Application 40 may list the location address or location name for which a specific application 40 is assigned within application 40 while client device 20 is at the assigned location.

Third party database interface 360 may facilitate data exchange with a third party database (e.g., database 86, etc.). For example, third party database interface 360 may receive inventory data from a third party database. In some embodiments, third party database interface 360 facilitates tracking inventory, purchases, etc. for a respective establishment to facilitate data analytics for inventory management, product marketing, financial management, and the like.

Content interface 370 may facilitate receiving content from third parties. For example, virtualization system 100 may receive social media content via content interface 370. Content may include media, audio, text, web pages, movies, photos, and any other content. In various embodiments, virtualization system 100 determines applications 40 require content and fetches the content via content interface 370. For example, an application 40 may display sales to a user in a specific location of a clothing store and may retrieve the sales content via content interface 370. In some embodiments, content interface 370 facilitates interaction between applications 40. For example, content interface 370 may facilitate social media posts tagging a location or announcing a purchase in a social media application 40 stemming from a merchandise application 40.

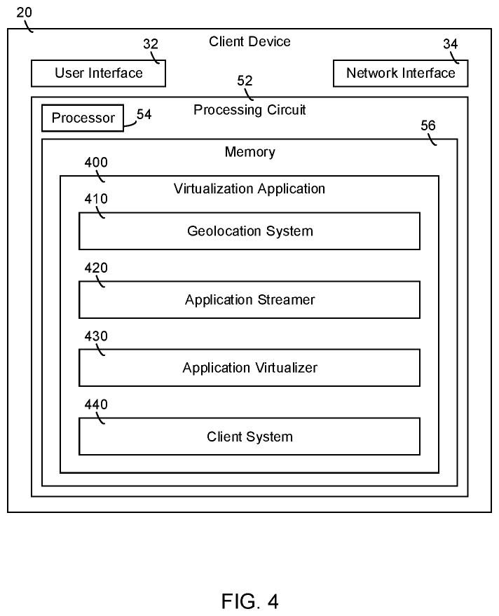

Referring now to FIG. 4, a block diagram illustrating an implementation of virtualization application 400 on client device 20 is shown. As discussed above, client device 20 may be a smartphone, a laptop, a smartwatch, a tablet, or any other such device. In various embodiments, client device 20 includes user interface 32, network interface 34, and processing circuit 52. User interface 32 may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). User interface 32 may be internal to the housing of client device 20, such as a built-in display, touch screen, microphone, etc., or external to the housing of client device 20, such as a monitor connected to client device 20, a speaker connected to client device 20, etc., according to various implementations. Network interface 34 may include any type of interface as described above for communicating with a network (e.g., network 60). In various embodiments, network interface 34 facilitates a cellular network connection or a connection to the Internet. Network interface 34 connect to any type and form of network, including local area networks (LANs), wide area networks (WANs) such as the Internet, satellite networks, cable networks, broadband networks, fiber optic networks, microwave networks, cellular networks, wireless networks, or any combination of these or other such networks. The networks may be the same type of network or different types, and may include a plurality of additional devices (not illustrated), including gateways, modems, firewalls, routers, switches, etc. The networks may also include any number of computing devices (e.g., computer, servers, routers, network switches, etc.) that are configured to receive and/or transmit data within the network. The network may further include any number of hardwired and/or wireless connections. Client device 20 may communicate wirelessly (e.g., via WiFi, cellular, radio, etc.) with a transceiver that is hardwired (e.g., via a fiber optic cable, a CAT5 cable, etc.) to other computing devices in the network. In some implementations, a network may be a virtual network, such as a virtual network between a plurality of virtual machines executed by a single physical machine, or an abstract network such as an offline transfer of data via physically movable media (e.g. a Sneakernet, transferring data via tape media, CD-ROM, flash media, external hard drives, floppy disks, etc.).

Memory 56 is shown to include virtualization application 400. Virtualization application may be any type of application as described above. In brief summary, virtualization application 400 may facilitate access to applications 40 run on virtualization system 100. For example, a user may view and interact with applications 40 through virtualization application 400 as if the applications 40 were installed natively on the client device 20. In some embodiments, users select applications 40 through a search feature or a map. Virtualization application 400 may be downloaded onto client device 20 via an application store such as the Apple Store, Android Store, etc. Virtualization application 400 may serve as a universal accessing medium for applications 40 on client device 20. Virtualization application 400 may facilitate many customization options and may be modified by the user to identify only certain applications 40 or integrate with various third party software, etc. In some embodiments, virtualization system 100 facilitates sharing of data within a network (e.g., a home application). For example, family members may share images, videos, and audio over the Internet or within a LAN. Additionally or alternatively, virtualization system 100 may facilitate sharing of data within a geofence. For example, files such as video, music, and photos, may be made available at a residence for download. In various embodiments, client device 20 may download content from virtualization system 100 and/or third party server 80 (e.g., applications 40, etc.) to client device 20. Virtualization system 100 may store information locally (e.g., videos, text, music, applications, purchase history, credit card information, etc.). In some embodiments, virtualization system 100 and/or virtualization application 400 facilitate design of customized applications with different functionality for sharing videos, music, photos, text, color, layouts, and pages. For example, a user may design a page that connect to other websites and social networks. Customized application data may be stored on virtualization system 100 and/or third party server 80. In some embodiments, the customized application includes instructions. For example, the customized application may include directions to a bathroom, shower operation instructions, and home care instructions. In some embodiments, the customized applications may integrate with the home application (e.g., a user may customize a home application). In some embodiments, guests may connect to the home application. In some embodiments, the home application may facilitate tracking. For example, the home application may keep inventory of what and/or who is in a house by connecting to user devices and/or synching to a refrigerator. In some embodiments, the home application may enable access restrictions. For example, a home application may include a resident access level and a guest access level. In some embodiments, the home application may facilitate home management. For example, the home application may facilitate monitoring utility consumption, security system access and monitoring, may sync with online recurring home payments and allow for in application payments for recurring home charges (e.g., utilities, alarm bills, mortgages, etc.). In some embodiments, one or more client devices 20 may connect to a home budgeting system to monitor purchases. For example, an administrator may pre-approve (e.g., for a shared credit card or a set of credit cards associated with the system) and set spending for other client devices 20 at certain stores/services, and monitor spending that is synced to the home budgeting system. In some embodiments, virtualization application 400 interfaces with mapping software. For example, virtualization application 400 may interact with third party mapping software to identify user use patterns. In some embodiments, virtualization application 400 integrates with third party server 80. For example, virtualization application 400 may integrate with third party maps software. In various embodiments, virtualization application 400 may identify a local code or geofence data using client device 20 hardware (e.g., camera for barcode scanning, Bluetooth transceiver, wireless transceiver, NFC transceiver, etc.). Virtualization application 400 may store data. For example, virtualization application 400 may store credit card information or past purchase information. In some embodiments, virtualization application 400 connects to a remote storage cloud that interacts with virtualization system 100. For example, virtualization system 100 may use data (e.g., credit card data, past purchase data, location data, etc.) from virtualization application 400 and/or the remote storage cloud. Virtualization application 400 may include geolocation system 410, application streamer 420, application virtualizer 430, and client system 440. Geolocation system 410 may facilitate sending and receiving location data with virtualization system 100. For example geolocation system 410 may send GPS coordinates associated with client device 20 to virtualization system 100. In various embodiments, geolocation system 410 interfaces with geolocation system 140 to pass location data between virtualization system 100 and client device 20. In some embodiments, specific applications 40 are available to client device 20 based on a physical location of the client device 20. In various embodiments, geolocation system 410 receives location data from client device 20 sensors. For example, geolocation system 410 may receive near field communication (NFC) data from NFC sensors on client device 20 to determine a position of the client device 20 relative to other objects. As a further example, geolocation system 410 may receive data from in-store hardware to increase the accuracy of the location tracking of client device 20. In some embodiments, geolocation system 410 facilitates real time tracking of client device 20. For example, geolocation system 410 may facilitate user location identification for a ride hailing application (e.g., Uber, etc.). Client device 20 may be configured to determine its current location and transmit its current location to virtualization system 100.

Application streamer 420 may send and receive streamed application data from virtualization system 100. In various embodiments, application streamer 420 receives streamed applications from application streamer 130 and send user application input to application streamer 130. For example, application streamer 420 may receive one or more interactable bitmap images to be converted for display to a user as an application. Application streamer 420 may receive user input to applications 40 and send the user input to virtualization system 100. In various embodiments, application streamer 420 interacts with application virtualizer 430. Application virtualizer 430 may present streamed applications to a user as if they were installed and run on the client device 20 directly. Application virtualizer 430 may receive streamed application data from application streamer 420 and format the application data for display to a user. Application virtualizer 430 may further receive user input to the streamed applications and send the user input to application streamer 420 for transmission to virtualizer system 100.

Client system 440 may exchange identifying information with virtualization system 100. For example, client system 440 may uniquely identify client device 20 to virtualization system 100 via a client identifier. Identifying information may include user credentials such as a user name, password, account name, account identifier, pass phrase, biometric data such as a fingerprint, facial scan data, retinal information, or voiceprint, or any other type and form of user-specific information. In various embodiments, client device 20 receives user credentials in response to display of a login prompt by virtualization application 400. In some embodiments, client device 20 stores user credentials temporarily, e.g. during execution of an application or for a predetermined time period. For example, a user may execute application 40 and provide credentials to the application, which may be sent to virtualization system 100 by client system 440. Subsequently, the user may elect to make a purchase, and virtualization system 100 may retrieve the user credentials from memory and provide the user credentials to an authentication server. In many implementations, user credentials may be encrypted, hashed, or otherwise obfuscated to protect user privacy and security. In many implementations, user credentials may be provided to an authentication server via an authentication process: the user credentials, or a hash of the user credentials, may be provided to authentication server, which may match the hash or credentials to those in a database of the server; upon identifying a match, the authentication server may determine the user or device is authorized or authentic, and may respond with an authorization token or other data indicating that the device is authorized. The device may utilize the authentication token with third party servers, applications, or other entities.

Referring now to FIG. 5, a signal flow diagram 500 illustrating an implementation of location based mobile applications is shown. At step 502, geolocation system 410 receives location data associated with client device 20. In various embodiments, geolocation system 410 may receive GPS data. In some embodiments, geolocation system 410 determines a location of client device 20 based on the location data. In some embodiments, geolocation system 410 and/or virtualization application 400 prompts the user to verify their current location (e.g., “Are you at establishment A?”, “Are you at establishment B or C?” etc.). At step 504, geolocation system 410 sends the location data to virtualization system 100 (via network interface 34, for example). At step 506, geolocation system 140 receives the location data and determines a physical location of client device 20 based on the received location data. In some embodiments, additional location data is used to determine a location of client device 20. For example, multilateration data from third party server 80 and/or third party device 90 may be used in combination with GPS data to determine a location of client device 20. At step 508, geolocation system 140 determines available applications 40 based on the determined location of client device 20. For example, a user may access a first application if client device 20 is determined to be within a geographic area (e.g., geofenced area, etc.). At step 510, virtualization system 100 sends the available applications 40 to client device 20. At step 512, client device 20 receives the available applications 40 and displays them to the user. At step 514, the user indicates a selected application 40 from the available applications. At step 516, client device 20 sends an indication of the selected application 40 to virtualization system 100. At step 516, virtualization system 100 receives the indication of the selected application 40 from the client device 20.

In some embodiments, at step 520, application virtualizer 120 and/or third party interface 300 determines that third party data is needed to display the selected application 40. At step 522, third party interface 300 sends a data request to third party server 80. For example, advertising interface 340 may send a request to an advertiser for a content item (e.g., an advertisement). At step 524, third party server 80 may receive the data request. At step 526, third party server 80 may retrieve the requested data, and at step 528 may send the retrieved data to virtualization system 100. At step 530, third party interface 300 may receive the sent data.

At step 532, application virtualizer 120 may virtualize application 40. Application virtualization may include running the application 40 on virtualization system 100 and sending the application data (e.g., user interface data elements, device operating system calls, notifications, etc.) to application streamer 130. At step 534, application streamer 130 may stream the application to client device 20. In various embodiments, application streamer 130 streams the application to application streamer 420. For example, application streamer 130 may format the application data as a mobile application for delivery to a smartphone client device 20. Additionally or alternatively, application streamer 130 may format the application data for display in another form (e.g., as a webpage, etc.). At step 536, application streamer 420 receives the streamed application and sends the streamed application to application virtualizer 430 for display on client device 20. In various embodiments, virtualization application 400 displays the application as if it were installed on client device 20 natively.

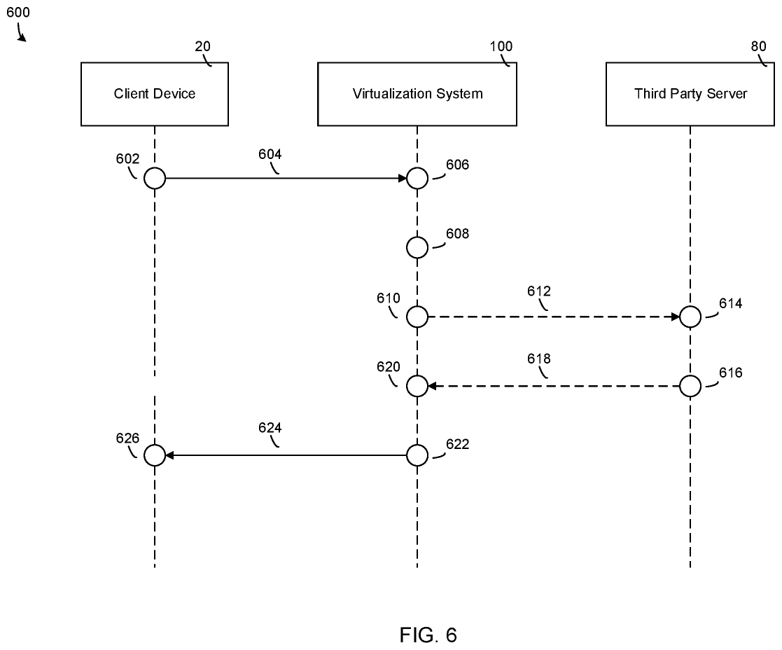

Referring now to FIG. 6, a signal flow diagram 600 illustrating an implementation of location based content items is shown. Similar to FIG. 5, at step 602, geolocation system 410 receives location data. In some embodiments, location data is GPS data. Additionally or alternatively, location data may be other data such as multilateration data or proximity data (e.g., NFC data). At step 604, geolocation system 410 sends the location data to virtualization system 100. At step 606, geolocation system 140 receives the location data and determines a location of client device 20. For example, geolocation system 140 may determine that the client device 20 is positioned in front of a clothing display at a clothing store. At step 608, geolocation system 140 and/or third party interface 300 may determine, based on the determined location of client device 20, a webpage to display to client device 20. At step 610, virtualization system 100 determines content included in the webpage.

In some embodiments, at step 612, third party interface 300 sends a request to third party server 80 for the content. The content may be advertising information, product information, coupons, pictures, videos, social media content, user interface elements (e.g., a virtual try on system, etc.), and any other content. At step 614, third party server 80 receive the request. At step 616, third party server 80 retrieves the content, and at step 618 third party server 80 sends the content to virtualization system 100. At step 620, third party interface 300 receives the content. At step 622, application virtualizer 120 virtualizes the application 40 using the received content and sends the virtualized application to application streamer 130 for streaming to the client device 20. In various embodiments, application virtualizer 120 virtualizes the application 40 by creating an interactable bitmap image from the user interface of the application 40. However, alternative methods of virtualization are possible. At step 624, application streamer 130 formats and transmits the virtualized application to the client device 20 for display as a webpage. At step 626, client device 20 receives the virtualized application and displays it as a webpage. In various embodiments, application streamer 420 receives the virtualized application stream and formats it for display as a webpage when passing it to application virtualizer 430 for display. Application virtualizer 430 may then display the received virtualized application stream as a webpage. Additionally or alternatively, the webpage may be displayed using a web hosting application. In various embodiments, the user is oblivious to the interaction between client device 20 and virtualization system 100 and only experiences the client device 20 opening a web page with a content item associated with their location.

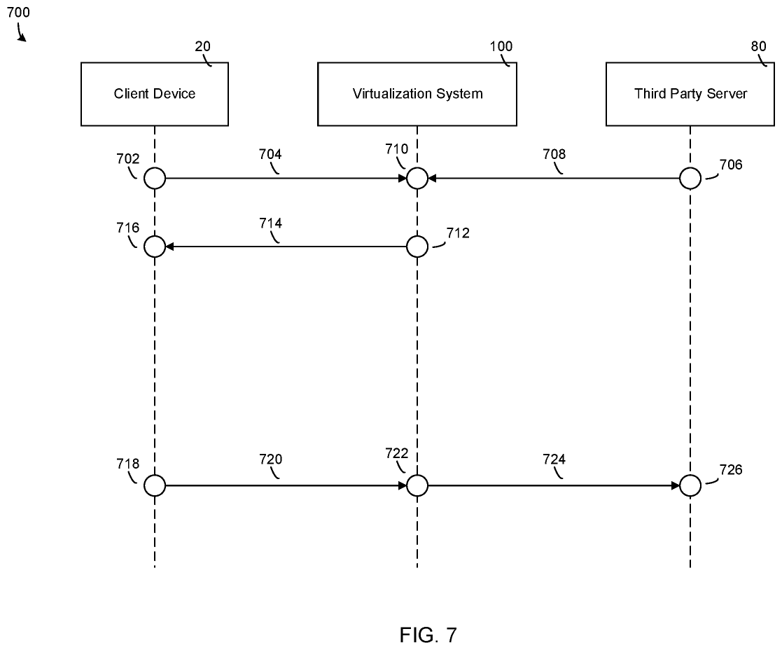

Referring now to FIG. 7, a signal flow diagram 700 illustrating an implementation of location based mobile applications interacting with third parties is shown. Similar to FIGS. 5-6, at step 702, geolocation system 410 receives location data. The location data may be GPS data. Additionally or alternatively, location data may include sensor data from one or more sensors at the physical location. For example, a store shelf may have a sensor that communicates with client device 20 to indicate a relative distance between the sensor and client device 20. As a further example, an item on a store shelf may have a GPS unit that communicates with client device 20 to indicate when the item has been moved. Additionally or alternatively, a user may capture image and/or video data of in store items and send that data along with the location data. At step 704, client device 20 sends the location data to virtualization system 100. Additionally or alternatively, geolocation system 410 may determine a location of client device 20 and send the location to virtualization system 100. At step 706, third party server 80 receives third party data. Third party server 80 may receive third party data from third party devices 90. For example, third party server 80 may receive sensor data (e.g., weight sensors, proximity sensors, Bluetooth data, RFID data, contact sensors, etc.), image and/or video data (e.g., from in store cameras, QR codes, etc.), and any other data. At step 708, third party server 80 sends the third party data to virtualization system 100. In some embodiments, virtualization system 100 receives third party data from a number of third parties. For example, virtualization system 100 may receive third party data describing an item a customer is interacting with from a first third party and may receive third party data describing an advertisement associated with the item from a second third party. At step 710, the location data and the third party data is received by virtualization system 100.

At step 712, virtualization system 100 prepares content to send to client device 20. In various embodiments, application virtualizer 430 prepares the content as described above. At step 714, virtualization system 100 sends the content to client device 20. At step 716, client device 20 displays the content. For example, the content may be product information associated with a product that virtualization system 100 determined the user is interacting with (e.g., via analyzing the location data and third party data, etc.). As a concrete example, virtualization system 100 may send promotions relating to merchandise that the user is in proximity to for display on the client device 20. As a further example, virtualization system 100 may determine (via client system 440) that a user is a male and may display a men's clothing catalog to the user via client device 20 when the user is in the shopping establishment. In some embodiments, third party advertisers may display content. For example, advertisers may display sales items to the user as the user walks through the store.

In some embodiments, virtualization system 100 facilitates conversion reporting. At step 718, a user interacts with the content displayed at step 716. For example, a user may select a promotion that is displayed. At step 720, client device 20 sends data relating to the user interaction with the content to virtualization system 100. For example, client device 20 may send a content identifier associated with the content the user interacted with. At step 722, virtualization system 100 receives the data relating to the user interaction with the content. In some embodiments, at step 724, virtualization system 100 sends the data to third party server 80, and at step 726, the third party server 80 receives the data. For example, virtualization system 100 may send the data to an advertising network.

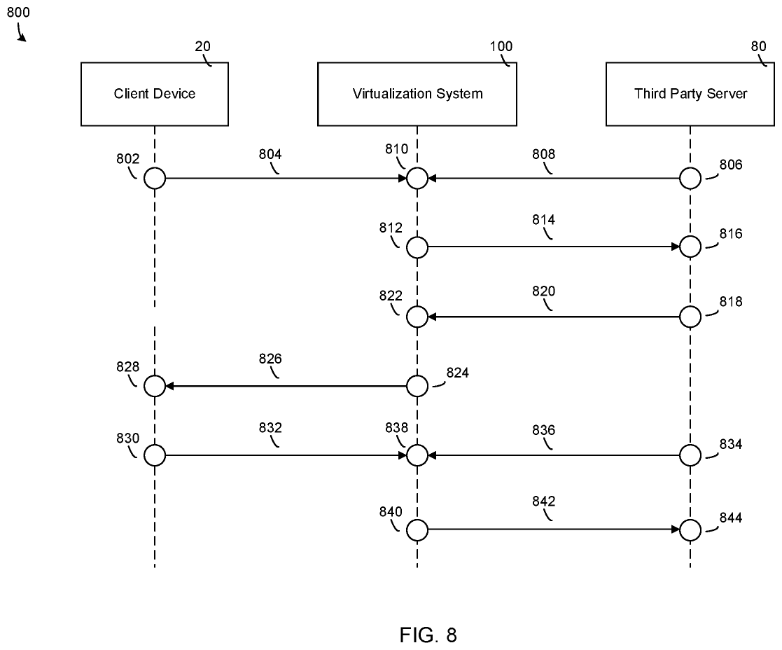

Referring now to FIG. 8, a signal flow diagram 800 illustrating an implementation of location based mobile applications performing data analysis with third parties is shown. At step 802, geolocation system 410 receives location data. At step 804, geolocation system 410 sends the location data to virtualization system 100. For example, the location data may indicate that a user is located in the dry goods isle of a supermarket. In some embodiments, transmission of location data is controlled by virtualization application 100. For example, an application 40 may only send location data when it is open. At step 806, third party server 80 receives data indicating user interaction with an item. For example, third party server 80 may receive weight sensor data from weight sensors associated with a dry good item in a supermarket. In some embodiments, the third party data includes image recognition data, such as image recognition data indicating that a user has picked up a dry good item. At step 810, virtualization system receives the location data and the third party data. At step 812, data analysis manager 250 determines, based on the received location data and third party data, that a user has selected an item. For example, data analysis manager 250 may determine based on location data indicating that a user is in the dry goods isle, third party data image recognition data that the user has picked up a dry goods item, and third party weight sensor data associated with a specific dry goods item, that the user has picked up a specific dry goods item. At step 814, third party interface 300 sends a request for information relating to the specific item to third party server 80. For example, the request may include a product identifier uniquely identifying the item the user has interacted with. In various embodiments, third party interface 300 may request information from a number of third party servers 80. For example, third party interface 300 may request ad data from a first third party server 80 and product information from a second third party server 80. In various embodiments, interaction with multiple third party servers 80 occurs simultaneously. At step 816, third party server 80 receives the request. At step 818, third party server 80 retrieves the information relating to the specific item, and at step 820, sends the information to virtualization system 100.

At step 822, third party interface 300 receives the information. At step 824, virtualization system 100 prepares content for client device 20. For example, the content may be a virtual shopping cart including the item the user has selected and product information associated with the item. In various embodiments, the content is prepared by application virtualizer 120 as described above. At step 826, application streamer 130 transmits the content to client device 20. In various embodiments, application streamer 130 transmits the content to multiple client devices 20. For example, multiple client devices 20 at multiple locations may receive the same content. Furthermore, multiple client devices 20 at the same location may also receive the same content. At step 828, client device 20, via application streamer 420 and application virtualizer 430, receives and displays the content. For example, client device 20 may add the item to the users shopping cart.

In some embodiments, virtualization system 100 interacts with client device 20 and/or third party server 80 to facilitate walkout purchasing. For example, virtualization system 100 may track a user as they select items in a store and may automatically purchase the items as the user leaves the store without the user having to go through a traditional checkout process. At step 830, geolocation system 410 receives location data. At step 832, geolocation system 410 sends the location data to virtualization system 100. At step 834, third party server 80 receives data indicating that the user is leaving the establishment. At step 836, third party server 80 sends the data to virtualization system 100. At step 838, virtualization system 100 receives the location data and the third party data and determines that a user is leaving the establishment. In some embodiments, geolocation system 410 determines the user is leaving the establishment directly and send an indication to virtualization system 100.

At step 840, virtualization system 100 determines which items the user has selected for purchase. In some embodiments, virtualization system 100 determines the items for purchase based on tracking the items the user has interacted with (as described in steps 802-812). At step 842, virtualization system 100 sends transaction data to third party server 80. For example, point of sale interface 350 may send transaction data describing a purchase amount associated with the items the user selected for purchase to a payment processor (e.g., a credit card company, etc.). In various embodiments, point of sale interface 350 may receive a payment confirmation from the payment processor and virtualization system 100 may provide the payment confirmation to client device 20. Virtualization system 100 may interact with a number of third party servers 80. For example, point of sale interface 350 may receive payment information (e.g., credit card information, etc.) from a first third party server 80 before sending the received payment information to a second third party server 80 (e.g., a payment processor). Additionally or alternatively, point of sale interface 350 may send transaction data describing the items the user has selected for purchase to a third party server 80 associated with the establishment. For example, point of sale interface 350 and/or third party database interface 360 may send a list of items to a third party server 80 associated with the supermarket to purchase the items and/or update an inventory database associated with the supermarket. At step 844, the third party server 80 may receive the data from point of sale interface 350.

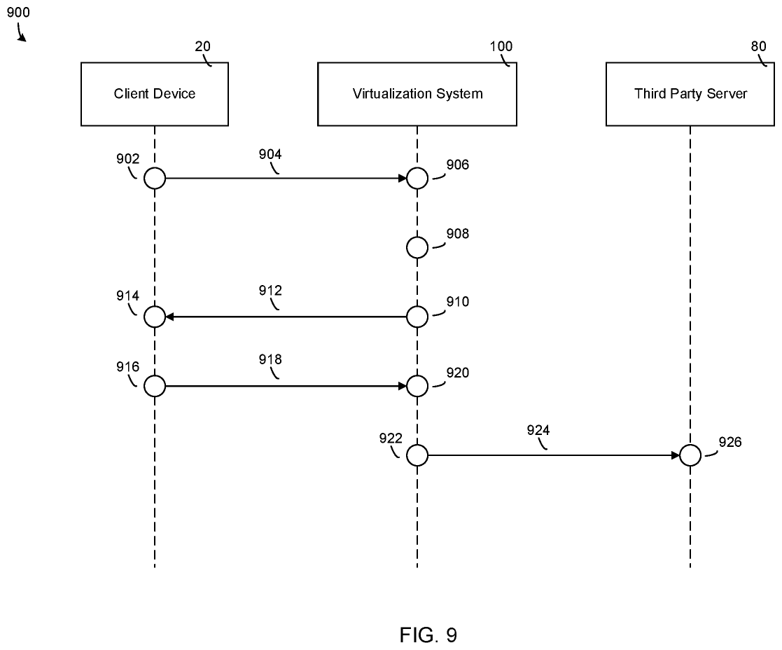

Referring now to FIG. 9, a signal flow diagram 900 illustrating an implementation of location based mobile applications performing location based sales approval is shown. In brief summary, virtualization system 100 may facilitate location based sales for applications 40. For example, a user may set a geographic area (e.g., a geofence, etc.) for which sales are pre-approved. As a concrete example, a user may determine that ice cream at vegan ice cream locations on weekends from 2-6 pm are pre-approved by virtualization system 100. At step 902, client device 20 generates a purchase request associated with a location. For example, a user using client device 20 may initiate a contactless payment with a point of sale terminal. At step 904, the purchase request and location data is sent to virtualization system 100. At step 906, the purchase request and location data is received by virtualization system 100. At step 908, virtualization system 100 may determine if the purchase request is approved. In some embodiments, user interface 260 may retrieve approved transaction rules associated with a user identifier of the client device 20 making the purchase request. For example, user interface 260 may determine the user identifier associated with the user making the purchase request and third party database interface 360 may query a third party database (e.g., database 88, etc.) to retrieve data describing approved transactions for the user. To continue the example, using the retrieved data, data analysis manager 250 may determine if the purchase request is approved.

At step 910, virtualization system 100 prepares content for client device 20. The content may include a message that describes an approval/rejection of the purchase request and may include interactive elements (e.g., dispute forms, etc.). Virtualization system 100 may prepare the content using application virtualizer 120 and application streamer 130 as described above. At step 912, virtualization system 100 transmits the content to client device 20, and at step 914, client device 20 receives and displays the content. For example, application virtualizer 430 may display a virtualized mobile banking application approving the purchase request. In some embodiments, the content requires user input (e.g., acknowledgment of the purchase request, authentication, approval/rejection of the purchase request, etc.). In some embodiments, virtualization system 100 sends the content via a call or text. In some embodiments, the content includes payment information. For example, the content may include a payment confirmation token that virtualization application 400 may pass to a point of sale terminal (e.g., via NFC, etc.) to complete the transaction. At step 916, virtualization application 400 receives user input. For example, the user may acknowledge the purchase request using the virtualized mobile banking application. At step 918, client device 20 may transmit the user input to virtualization system 100, and at step 920, virtualization system 100 may receive the user input.

In some embodiments, virtualization system 100 completes the payment process with third party server 80. For example, virtualization system 100 may send approved purchase requests to a payment processor. Additionally or alternatively, virtualization system 100 may perform post-transaction functions. For example, virtualization system 100 may update an accounting database associated with a business to associate the purchase request with a business expense. At step 922, virtualization system 100 may prepare data for transmission. The data may describe the purchase request, purchase location, the user(s) associated with the purchase, and/or other information related to the purchase. At step 924, virtualization system 100 transmits the data, and at step 926, third party server 80 receives the data. For example, advertising interface 340 may send conversion data to an advertiser, point of sale interface 350 may send payment information to a payment processor, third party database interface 360 may send metadata to an establishment associated with the purchase, etc. among other possible post-transaction functions. As a concrete example, real time data may be transmitted to third party server 80 to provide up-to-date inventory and purchasing capabilities. It is important to note that virtualization application 400 may perform any of the actions described above in reference to the client device 20. For example, at step 918, although client device 20 is described as transmitting user input to virtualization system 100, virtualization application 400 (or a component thereof) may just as easily perform this function.

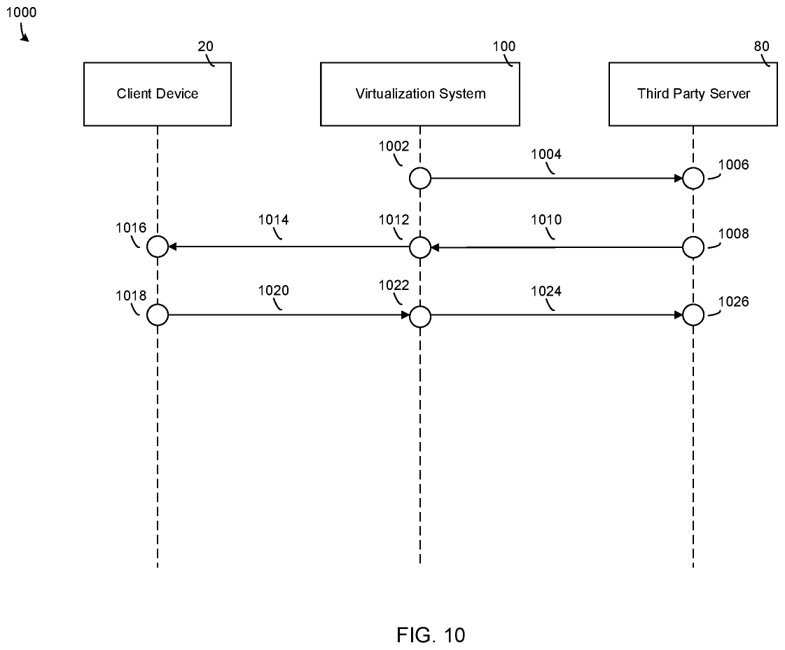

Referring now to FIG. 10, a signal flow diagram illustrating an implementation of remotely stored mobile applications integrating with third party software is shown. In various embodiments, visualization system 100 integrates with third parties (e.g., third party software, third party programs, third party servers, etc.) instantaneously. For example, a user may make a purchase in a remotely hosted application (e.g., an in-app purchase) and visualization system 100 may send the purchase data to multiple recipients (e.g., third party inventory management software, third party supply chain software, third party financial management software, location point of sale systems, etc.) instantaneously for further action (e.g., third party inventory management software may update local inventories and displays, etc.). In some embodiments, application virtualization is distributed. For example, virtualization may occur on a multiple servers in parallel. In some embodiments, applications are virtualized on a different system than they are stored on. For example, a first server may store applications 40 and a second server may virtualize the stored applications 40. In some embodiments, a portion of the data used for application virtualization is stored on other servers (e.g., third party servers, distributed servers, etc.). In some embodiments, code retrieval (e.g., virtualization) occurs from a local code emitting device (e.g., third party device 90, etc.). For example, a local device located at an entry to an establishment may have a code received by client device 20 (e.g., via wireless network, Bluetooth, NFC, barcode scan, etc.) that is sent to virtualization system 100 to initiate application streaming to client device 20. In some embodiments, third party resources (e.g., programs, software, databases, etc.) may integrate with virtualization system 100 without third party server 80. For example, third party software may integrate with virtualization system 100 through a local non-server system (e.g., a handheld device, etc.). In various embodiments, virtualization system 100 is or includes an internal server (e.g., a server associated with an establishment). For example, virtualization system 100 may be implemented on a server associated with a retailer. Additionally or alternatively, virtualization system 100 may be at least partially distributed in a distributed processing system. For example, virtualization system 100 may be expanded (e.g., to have increased storage and/or processing capabilities, etc.) across a number of servers. As a concrete example, a first server associated with the establishment may host virtualization system 100 and a first number of applications 40 and a second server maintained by an external party may host a second number of applications 40 and interface with the first server to provide the second number of applications 40 to the virtualization system 100. In some embodiments, third party servers 80 facilitate storage and interaction with non-in-service software (e.g., outside supply chain management software, inventory management software, etc.). To continue the previous example, a third party server 80 may host inventory management software and interface with the first server to provide the inventory management software to virtualization system 100.

At step 1002, virtualization system 100 determines a data request for third party server 80. The data request may include inventory data, supply chain data, financial data, and/or location data. At step 1004, virtualization system 100 transmits the data request to third party server 80, and at step 1006, third party server 80 receives the data request. In various embodiments, the data request is an interaction with third party content (e.g., software, programs, etc.). At step 1008, third party server 80 retrieves the data and at step 1010, third party server 80 sends the data to virtualization system 100. At step 1012, virtualization system 100 prepares a virtualized application for client device 20, and at step 1014 virtualization system 100 streams the virtualized application to client device 20. At step 1016, client device 20 receives and displays the virtualized application. At step 1018, a user interacts with the virtualized application. For example, a user may make an in app purchase request. At step 1020, client device 20 transmits the interaction data to virtualization system 100, and at step 1022, virtualization system 100 receives the interaction data. The interaction data may describe interaction with third party content such as third party inventory management software, third party supply chain software, third party financial management software, and location point of sale systems. At step 1024, virtualization system 100 transmits an update request to third party server 80. The update request may facilitate updating of third party content (e.g., software, programs, etc.). At step 1026, third party server 80 receives the update request and performs an update. For example, third party server 80 may update local location inventory systems and/or visualization systems.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the virtualization system 100, third party interface 300, and virtualization application 400 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An application virtualization system, comprising:
an application repository storing applications, wherein at least one of the applications is associated with a geofence; and
a processing circuit comprising at least one processor and memory, the memory having instructions stored thereon, that when executed by the at least one processor cause the processing circuit to:
receive location data from a client device;
determine a current location of the client device based on the location data;
compare the current location to the geofence of the at least one application; and
provide the at least one application to the client device based on the comparison;
wherein the applications are not stored locally on the client device.

2. The application virtualization system of claim 1, wherein the applications are mobile applications and the client device is a smartphone.

3. The application virtualization system of claim 1, further comprising a user interface configured to:
receive geofence data from a user; and
create a new geofence associated with one or more of the applications based on the geofence data.

4. The application virtualization system of claim 4, wherein the user interface is further configured to:
receive from the user preapproved spending data indicating an area where purchases having a first set of attributes are preapproved; and
create a new preapproved spending geofence based on the preapproved spending data.

5. The application virtualization system of claim 1, the memory further comprising instructions, that when executed by the at least one processor cause the processing circuit to send data to the client device for storage locally on the client device.

6. The application virtualization system of claim 1, the memory further comprising instructions, that when executed by the at least one processor cause the processing circuit to receive real time location data from the client device.

7. The application virtualization system of claim 6, the memory further comprising instructions, that when executed by the at least one processor cause the processing circuit to store the real time location data in a database and provide the real time location data to a third party.

8. A mobile device, comprising:
a processing circuit comprising at least one processor and memory, the memory having instructions stored thereon, that when executed by the at least one processor cause the processing circuit to:
provide a virtualization application on the mobile device, the virtualization application configured to:
generate location data based on one or more received sensor signals;
send location data to an application virtualization system, the location data describing a current location of the mobile device;
receive virtualized application data associated with an application stored on the application virtualization system from the application virtualization system, wherein the application is associated with a current location of the mobile device; and
provide the application to the mobile device;
wherein the application is not stored locally on the mobile device.

9. The mobile device of claim 8, wherein the one or more received sensor signals comprise near field communication (NFC) signals.

10. The mobile device of claim 8, wherein providing the application to the mobile device includes running the application remotely on the application virtualization system and displaying a user interface associated with the application on the mobile device.

11. The mobile device of claim 8, wherein the virtualization application receives data from the application virtualization system for storage on the mobile device.

12. The mobile device of claim 8, wherein the virtualization application is configured to provide multiple applications to the mobile device at the same time.

13. The mobile device of claim 8, wherein the virtualization application is further configured to provide real time location data to the application virtualization system.

14. An application virtualization system, comprising:
an application virtualizer configured to provide an application to a client device based on a physical location of the client device;
wherein the application is not installed on the client device; and
a third party interface configured to:
receive third party data, the third party data describing a physical interaction associated with a user of the client device at the physical location; and
update the application provided to the client device based on the third party data.

15. The application virtualization system of claim 14, wherein the third party data is inventory data and updating the application includes displaying the inventory data on the client device.

16. The application virtualization system of claim 14, wherein the third party data is point of sale data and updating the application includes completing a transaction on the client device.

17. The application virtualization system of claim 14, wherein the third party data is an advertisement associated with the physical location of the client device and updating the application includes displaying the advertisement.

18. The application virtualization system of claim 14, wherein the third party data is a webpage and updating the application includes displaying the webpage on the client device.

19. The application virtualization system of claim 14, wherein the third party data is product information associated with a product associated with the physical interaction and updating the application includes displaying the product information on the client device.

20. The application virtualization system of claim 14, wherein the third party data is an item selection associated with the physical interaction and updating the application includes adding the item to an online shopping cart on the client device.
